(19) United States
(12) Patent Application Publication
(10) Pub. No.: US 2006/0072070 A1
(43) Pub. Date: Apr. 6, 2006

(54) Manufacturing of lens elements

(75) Inventors: Stein Kuiper, Eindhoven (NL); Edwin Maria Wolterink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,915

(22) PCT Filed: Oct. 31, 2003
(86) PCT No.: PCT/IB03/04971

§ 371 Date: May 31, 2005

(30) Foreign Application Priority Data
Dec. 3, 2002 (EP) 020800595

(51) Int. Cl. G02C 7/02; B29D 11/00; G02B 1/00

(52) U.S. Cl. 351/177; 264/1.36

(57) ABSTRACT

A method of the manufacture of an optical lens element. The method comprises providing a fixable liquid (A) separated from a different liquid (B) by a meniscus (12); varying a curvature of the separating meniscus (12) and fixing the shape of the fixable liquid when the curvature has a desired configuration.

The field of the present invention relates to the manufacture of optical lens elements to be used for example as ophthalmic lenses. The invention is particularly, but not exclusively, relevant to the production of ophthalmic lenses specific to a patient's optical requirements, for example contact lenses.

In the manufacture of optical lenses, the precise curvature of the faces of the lens is essential in determining the refractive characteristics of the lens.

Current lens manufacturing methods include machining and polishing, injection moulding and replication techniques. These methods involve complex machines and in the case of ether injection moulding or replication the use of fixed moulds limits flexibility over the shape of the lens being manufactured. Machining and polishing is expensive and not time efficient.

It is an object of the present invention to provide an improved method of manufacture of an optical lens element. It is a further object of the present invention to provide apparatus for the improved manufacture of an optical lens element.

In accordance with one aspect of the invention there is provided a method of the manufacture of an optical lens element, said method comprising: providing a fixable liquid separated from a different fluid by a meniscus; varying a curvature of the separating meniscus; and fixing the shape of the first liquid when the curvature has a desired configuration.

In accordance with a further aspect of the invention there is provided an apparatus for the manufacture of an optical lens element, said apparatus including: a receptacle for receiving a fixable insulating liquid and an electrically conducting fluid, said fluids separated from each other by a fluid meniscus; an electrode configuration arranged to enable the curvature of the fluid meniscus to be varied; and means for fixing the shape of the fixable liquid.

The new method and apparatus provided by the present invention for lens manufacture are efficient and result in the production of lenses of accurate dimensions.

The present invention in one embodiment employs a method and apparatus based on an electrowetting process. By variation of an applied voltage the exact curvature of one, or each, face of the lens to be manufactured can be precisely controlled. This allows individual lenses to be manufactured which differ from each other by a minute level of refractive characteristics thus providing a more precise lens specification to meet the needs of the application.

In one aspect of the present invention, a lens manufacture process and apparatus are provided whereby it is possible for ophthalmic lenses to be manufactured on-site after an eye test. Complex lens shapes, having more exact corrective characteristics than conventional on-site lens stocks, can thereby be provided to a patient following an eye test.

Further features and advantages of the invention will become apparent from the following description of preferred embodiments of the invention, wherein:

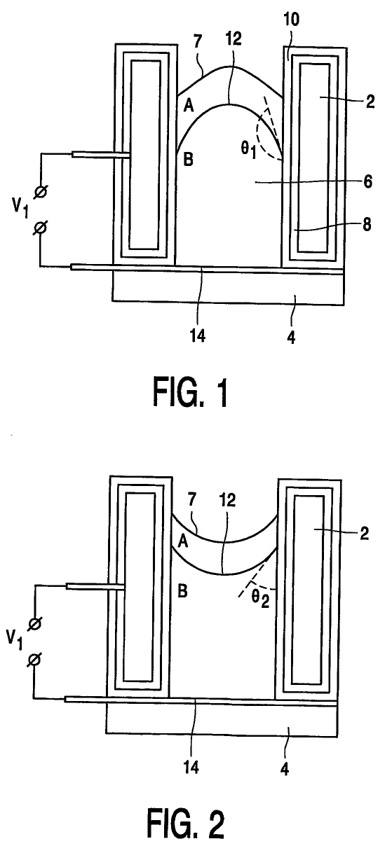

FIGS. 1 and 2 show a simplified cross-section of the present invention, showing two different states of meniscus curvature; and

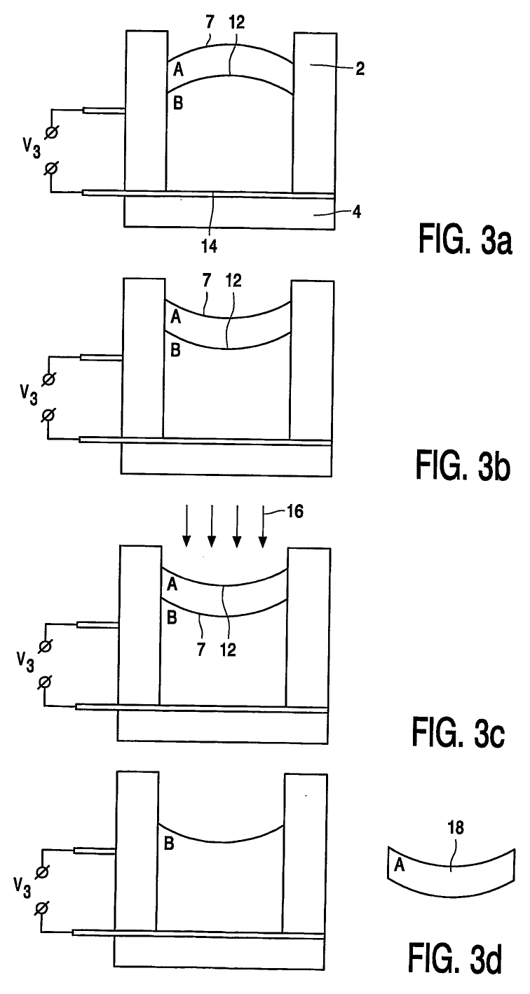

FIGS. 3 to 5 show schematically method steps of embodiments of the present invention for lens manufacture;

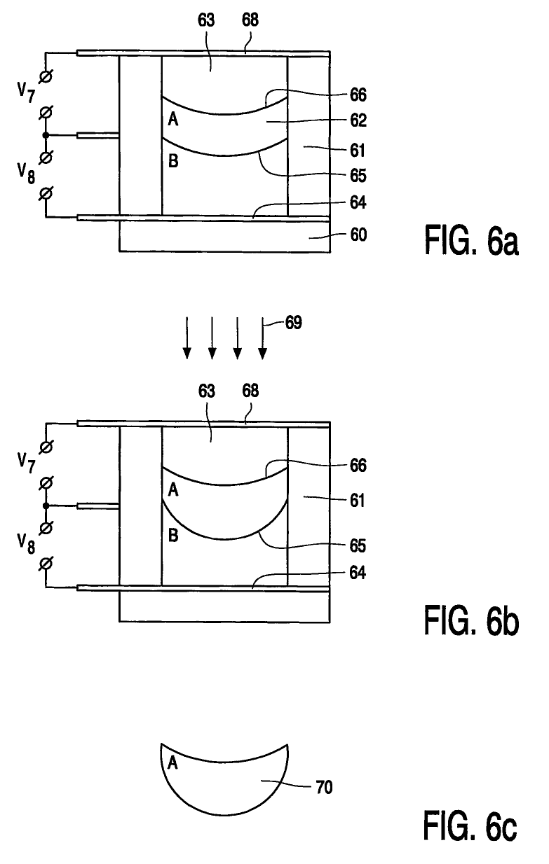

FIG. 6 shows a simplified cross-section of apparatus used for ophthalmic lens manufacture at various method steps according to an embodiment of the present invention;

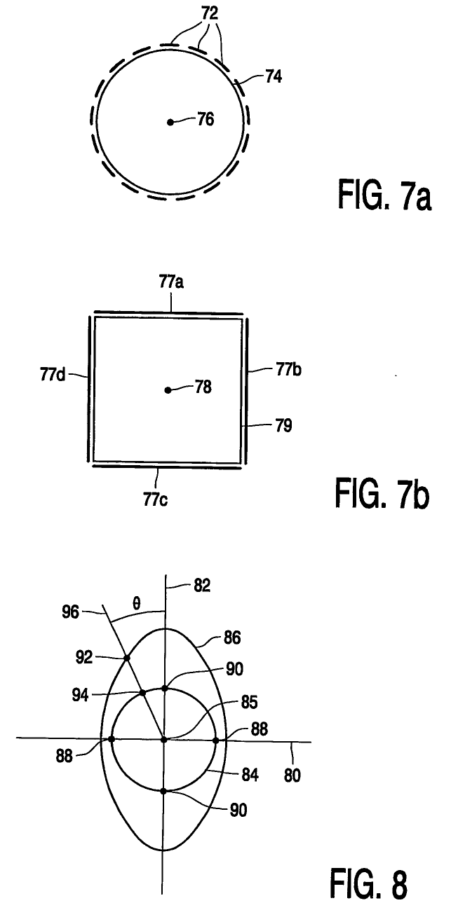

FIG. 7 shows in cross-section configurations of electrodes for use in embodiments of the present invention; and

FIG. 8 shows a graphical representation of an applied voltage across an electrode configuration according to an embodiment of the present invention.

FIGS. 1 and 2 show a possible construction of an embodiment of the present invention allowing variation of the curvature of a fluid meniscus. The construction comprises a first electrode 2, preferably cylindrical and base sealed by means of a base element 4 to form a fluid container 6.

In this embodiment, the fluid container 6 contains two fluids consisting of two non-miscible liquids in the form of an electrically insulating non-polar fixable first liquid A, for example a preferably transparent acrylic or epoxy lacquer, and an electrically conducting and polar second liquid B, for example an aqueous salt solution. Liquid A lies on the upper surface of liquid B. The upper surface 7 of liquid A in this embodiment interfaces with a fluid material, for example a gas, and may be exposed to the atmosphere.

The first electrode 2 is a cylinder of inner radius typically between 1 mm and 20 mm. The electrode 2 is formed from a metallic material and is coated by an insulating layer 8, formed for example of parylene. The insulating layer has a thickness of between 50 nm and 100 μm, with typical values between 1 μm and 10 μm. The insulating layer is coated with a fluid contact layer 10, which reduces the hysteresis in the contact angle of the meniscus 12 with the cylindrical wall of the fluid chamber. The fluid contact layer is preferably formed from an amorphous fluorocarbon such as Teflon™ AF1600 produced by DuPont™. The fluid contact layer 10 has a thickness of between 5 nm and 50 μm. The AF1600 coating may be produced by successive dip coating of the electrode 2, which forms a homogeneous layer of material of substantially uniform thickness since the cylindrical sides of the electrode are substantially parallel to the cylindrical electrode; dip coating is performed by dipping the electrode whilst moving the electrode in and out of the dipping solution along its axial direction. The parylene coating may be applied using chemical vapor deposition.

A second electrode 14 is arranged at the base end of the cylindrical electrode 2, adjacent the base element 4. The second electrode 14 is arranged with at least one part in the fluid chamber such that the electrode acts on liquid B.

The two liquids A and B are non-miscible so as to tend to separate into two fluid bodies separated by a meniscus 12. Due to electrowetting, the wettability of the fluid contact layer by liquid B varies under the application of a voltage between the first electrode 2 and the second electrode 14, which tends to change the contact angle of the meniscus 12 at the three phase line (the line of contact between the fluid contact layer 10 and the two liquids A and B). The shape of the meniscus is thus variable in dependence on the applied voltage. The two liquids are preferably arranged to have substantially equal densities, to avoid gravitational effects between the two liquids. In an envisaged alternative liquid A can be of a lower density than liquid B.

Referring now to FIG. 1, when a low voltage V₁, e.g. between 0 V and 20 V, is applied between the electrodes the lower meniscus 12 adopts a first meniscus shape which is concave, when viewed from below the first liquid A. The upper meniscus 7 of liquid A is of a shape which is convex, when viewed from above the first liquid A. Note that, hereinafter, descriptions of the curvature of either fluid separating menisci, or an upper surface of the first fluid A, as concave or convex will relate to similar viewing from outside liquid A; in the case of a lower meniscus of liquid A the curvature is viewed from below, and in the case of an upper meniscus or upper surface of liquid A the curvature is viewed from above.

In the configuration of FIG. 1, the initial contact angle θ₁ between the lower meniscus and the fluid contact layer 10, measured in the fluid B, is for example approximately 140°. To reduce the concavity of the lower meniscus shape, V₁ is increased to a higher magnitude of voltage, e.g. between 20 V and 150 V, depending on the thickness of the insulating layer.

To produce a convex lower meniscus shape, a yet higher magnitude of voltage is applied between the first and second electrodes. Referring now to FIG. 2, V₁ is increased to a relatively high voltage, e.g. 150 V to 200 V and the lower meniscus 12 adopts a shape in which the meniscus is convex. In this configuration, the maximum contact angle θ₂ between the first liquid A and the fluid contact layer 10 is for example approximately 60°.

Note that, whilst achieving the configuration of FIG. 2 is possible using a relatively high voltage, it is preferred in a practical embodiment that a device for lens manufacture as described is adapted to use only low and intermediate voltages in the ranges described, that is to say that the voltage applied is restricted such that the electrical field strength in the insulating layer is smaller than approximately 20 V/μm depending on the insulating layer material. Excessive voltages which cause charging of the fluid contact layer, and hence degradation of the fluid contact layer, are not used.

FIG. 3 shows schematically a method of the current embodiment of the present invention wherein a lens is manufactured. In this embodiment both faces of the lens produced are aspherical and substantially parallel to each other and thus of substantially the same curvatures. Referring now to FIG. 3a, a starting voltage V₃ of zero is applied across the electrodes 14, 2, and the lower meniscus 12 adopts a first concave shape, as earlier described. As shown now in FIG. 3b, applying voltage V₃ across the electrodes 14, 2 causes the lower meniscus 12 to now adopt a convex shape, the curvature of which is generally adopted also by the upper meniscus 7. The specific curvatures of the lower meniscus 12 and therefore the upper meniscus 7 depend upon the specific value of the applied voltage V₃. Variation of the applied voltage may for example be achieved by using a variable resistance element. The applied voltage may be varied by a skilled operator, or automatically depending on input lens characteristic data. In the case of control by a skilled operator, the apparatus includes means for displaying data relating to the curvature of the meniscus to the operator. Such a data display could for example be a liquid crystal display (LCD).

Referring to FIG. 3c, when the curvature of the lower meniscus 12 matches the desired lens face curvature that is desired, the current applied voltage V₃ is maintained. The desired curvature of the lens faces is determined by the refractive characteristics of the desired lens to be manufactured. Liquid A is now fixed in shape using a method appropriate to the chemical nature of liquid A. For example when liquid A is a lacquer, its shape can be fixed by the application of ultraviolet irradiation 16. This curing causes the lacquer to be fixed in a shape with faces of a generally exact curvature of the lacquer of liquid A at the current applied voltage V₃.

As shown in FIG. 3d now fixed lacquer of liquid A can be removed from the upper surface of the liquid B. In this embodiment where the lacquer of liquid A is transparent, the now rigid lacquer is an optical lens 18.

Note that, in the alternative to curing the lacquer of liquid A when the meniscus is in a convex shape, the, or another, desired lens curvature may also be obtained by curing the lacquer of liquid A when the meniscus is in a concave shape.

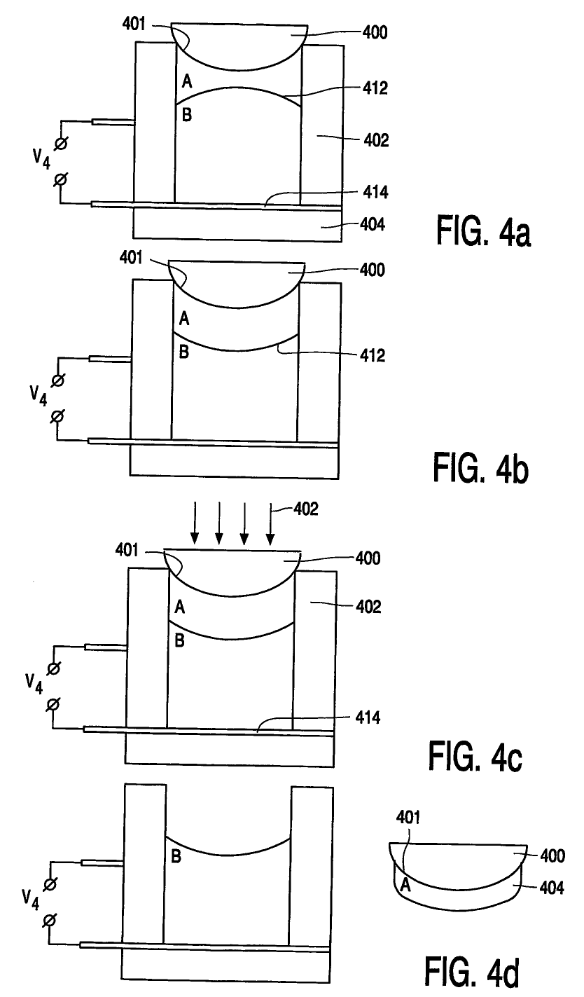

FIG. 4 gives a schematic diagram of an alternative embodiment of the present invention. In this embodiment it is possible to manufacture a lens whereby each of the two faces has a substantially different curvature. Viewing FIG. 4a, this embodiment is similar in various respects to the embodiment previously described. Elements similar to that described in relation to FIGS. 1, 2 and 3 are provided in FIG. 4 incremented by 400, and the previous description should be taken to apply here. In this embodiment, the upper surface of liquid A is no longer a meniscus interface with the atmosphere but lies in contact with the lower surface 401 of a substrate 400. The substrate 400, formed for example of glass or moulded plastics material, is positioned as a top element over the top opening of the cylindrical electrode 402. The lower surface 401 of the substrate 400 is shaped to effectively seal the top opening of the electrode 402 and to describe the desired curvature of the upper surface of the lens to be manufactured. This desired curvature could for example be selected to match the curvature of the surface of a patient's eyeball.

Substrate 400 could be for example a lens body or simply a substrate to which it is desired to mount the manufactured lens in preparation for an application or for further modifications. The lower surface 401 of the substrate 400 can take the form of a plurality of shapes, for example curved or flat, as desired. In this embodiment the lower surface 401 of the substrate 400 is convex when viewed from below. In a preferred embodiment, the lower surface 401 is spherical in shape. Alternatively, it is possible for the lower surface 401 to be aspherical in shape as this can help to correct spherical optical aberrations arising from the fluid meniscus 412.

The method for lens manufacture in this embodiment of the invention is similar in manner to that of the previous embodiment and illustrated using FIG. 3. FIG. 4a shows the substrate 400 positioned over the top end of the cylindrical electrode 402 with a convex curved lower surface 401. Substrate 400 may itself be a lens and is arranged to seal the top end of the cylindrical electrode 402. At an applied voltage V₄ of zero across electrodes 402 and 414, the meniscus 412 has a concave curvature but the upper surface of liquid A lies along the lower curved surface 401 of the substrate 400. In FIG. 4b a different applied voltage V₄ is placed across electrodes 402 and 414. The meniscus 412 now adopts a convex curvature. The upper surface of liquid A still lies along the lower curved surface 401 of substrate 400. As FIG. 4c shows, liquid A is cured to rigidly fix the shape, for example by irradiation with ultraviolet light 402 when liquid A is a lacquer, once the desired curvature of the meniscus 412 is achieved. As according to the previous embodiment, the desired curvatures of the faces of the lens to be manufactured are determined by the desired refractive characteristics of the lens. During curing the currently applied voltage V₄ for the desired curvature of the meniscus is maintained.

FIG. 4d shows that the now solid lacquer of liquid A has a shape with curved upper and lower faces corresponding to the curvatures of the lower surface 401 of the substrate 400 and the meniscus 412 respectively. The rigid transparent lacquer of liquid A forms a fixed layer 404 attached along its upper surface to the lower surface 401 of the substrate 400. The layer 404 and substrate 400 may together form the lens. Alternatively, the lower surface 401 may be coated with a non-adhesive layer such that the layer 404 and the substrate 400 may be separated if desired to form a lens, for example a contact lens, from the layer 404 alone.

Note that, in the alternative to curing the lacquer of liquid A when the meniscus is in a convex shape, the, or another, desired lens curvature may also be obtained by curing the lacquer of liquid A when the meniscus is in a concave shape.

Note that, although the upper face of substrate 400 is shown as a planar surface, the surface may also take a convex or concave shape.

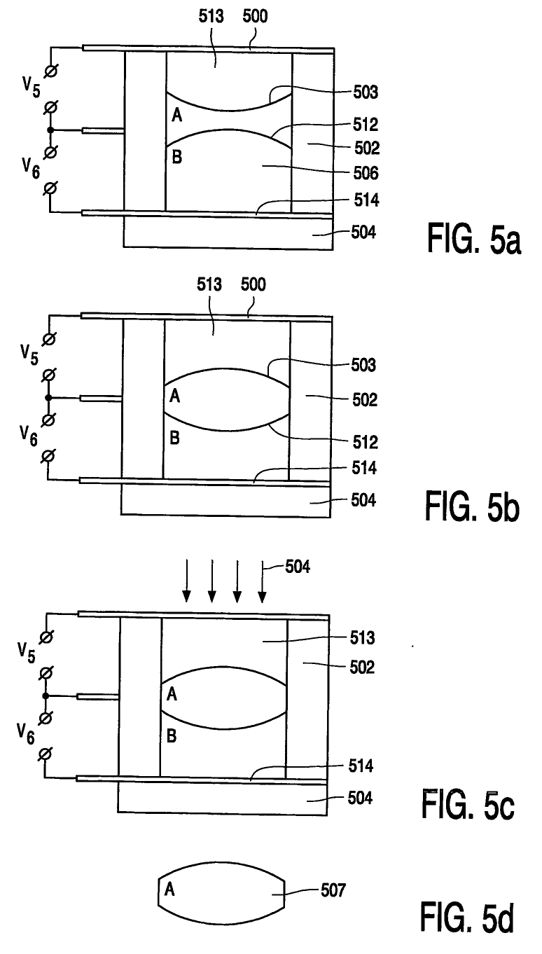

FIG. 5 shows a yet further embodiment of the present invention allowing the manufacture of a lens with each face being of individually controllable different curvatures.

As shown in FIG. 5a, this embodiment of the present invention is generally similar to the previously described embodiment using FIGS. 1 to 2. Elements similar to those described in relation to FIGS. 1 and 2 are provided with the same reference numerals, incremented by 500 and the previous description should be taken to apply here. At the top end of cylindrical electrode 502 is positioned a third electrode 500. This may be similar in form to the second electrode 514, but is removable to allow access to the fluid container 506.

In this embodiment the fluid container 506 holds three fluid layers. The first fluid layer comprises liquid B, the lower surface of which is in part contact with electrode 514. The second fluid layer comprises the liquid A with its lower surface in contact with the upper surface of the first layer, thus forming a first meniscus 512.

In this embodiment, a third fluid layer 513 exists with its lower surface in contact with the upper surface of the second layer thus forming a second meniscus 503. The upper surface of the third layer 513 is in contact with at least part of the third electrode 500 such that the electrode acts upon the third fluid layer 513. The third layer may comprise the same fluid as liquid B, or may be an alternative fluid which is non-miscible with liquid A and electrically conductive. In addition, the fluid of the third layer is preferably of substantially equal density to liquid A and liquid B. It is alternatively possible though that the fluid of the third layer is of a lower density than liquids A and B. Both liquids A and B are as described in previous embodiments.

In practice, the three individual fluid layers are inserted in turn, according to their position in the fluid layer structure, into the fluid container 506. This is achieved by removal of the third electrode 500 and insertion of the fluid layers through the resulting top opening of the first electrode into the fluid container 506. Once the three layers have been inserted, the third electrode 500 is replaced over the top end opening of the first electrode 502 thus sealing the fluid container 506. An alternative envisaged method involves the injection of the fluids into the fluid container 506 through an opening in the third electrode which is positioned over the top end opening of the first electrode. The fluid layer insertion for both of these techniques could be achieved using a fluid insertion device capable of repeatedly inserting measured volumes of fluid into the fluid container.

The voltage levels across electrodes 514 and 502, and electrodes 500 and 502, respectively, are controllable independently. Variation of the applied voltage Vs across electrodes 514 and 502 results in the variation of the curvature of the first meniscus 512 as previously described. Variation of the applied voltage V₆ across electrodes 500 and 502 results in a similar variation in the curvature of the second meniscus 503.

As shown in FIG. 5a, the first meniscus 512 adopts a concave curvature when viewed from the second fluid layer when the applied voltage V₅ or V₆ equals zero. The second meniscus 503 similarly adopts a concave curvature.

FIG. 5b shows that with a selected different applied voltage Vs or V₆, the second meniscus 503 and/or the first meniscus 512 respectively may adopt an opposite curvature relative to the original curvature. The value of the applied voltages Vs and V₆ can differ from each other and be varied independently. Consequently the curvatures of the second meniscus 503 and the first meniscus 512 can differ from each other.

As shown in FIG. 5c, once the individual curvatures of the second and first menisci 503 and 512 are as desired, according to the desired refractive characteristics of the lens to be manufactured, liquid A is cured to fix its shape, for example by ultraviolet irradiation 504 with liquid A as a lacquer. The now solid lacquer of liquid A has one upper and one lower face which match the independently controlled curvatures of the menisci 503 and 512 respectively.

Once removed from the fluid container 506, the now fixed lacquer of liquid A, when formed from the preferred transparent lacquer, is the manufactured optical lens 507 as desired, shown in FIG. 5d.

Note that, in the alternative to curing the lacquer of liquid A when the first and/or second meniscus is in a convex or concave shape respectively as described, the, or another, desired lens curvature may also be obtained by curing the lacquer of liquid A when one, or each of, the menisci is of a configuration having an opposite curvature.

FIG. 6 shows a further embodiment of the invention, in which there is provided a method of manufacture, and a construction of a variable meniscus manufacturing apparatus suitable for manufacturing ophthalmic lenses for a patient. The lenses could be contact lenses or spectacle lenses. The construction of the apparatus is generally similar to that of the variable meniscus apparatus described in the previous embodiment using FIG. 5. In this embodiment the second meniscus curvature is controlled using an applied voltage unlike the previous embodiment.

The first electrode 61 is preferably cylindrical and base sealed by means of base element 60 to form fluid container 62. Fluid container 62 holds three fluid layers.

The first fluid layer consists of liquid B, the bottom surface of which is in part contact with the second electrode 64. The second electrode 64 is arranged at the base end of the cylindrical electrode 61. The second fluid layer consists of liquid A with its bottom surface in contact with upper surface of the first layer, thus forming a first fluid meniscus 65. In this embodiment, liquid A is electrically insulating, non-miscible with the other fluids in layers and of a suitable chemical nature for the manufacture of contact lenses or spectacles. This may be in the form of a transparent liquid lacquer.

The third fluid layer 63 with its lower surface in contact with the upper surface of said second fluid layer thus forming a second fluid meniscus 66. The upper surface of the third layer is in contact with at least one part of a third electrode 68 such that the electrode acts on the third fluid layer. The third electrode 68 is arranged at the top end of cylindrical electrode 61. The third fluid layer 63, as according to the previous embodiment, may comprise a fluid of preferably substantially equal density to the fluid of the second fluid layer, although in an alternative embodiment a fluid of a lower density is used. Liquid B may be as described in the first embodiment. The fluid layers are inserted into the fluid container 62 by a similar method to that of the previous embodiment where the third electrode 68 is removed and replaced, or by injection of fluids into the fluid container 62 through an opening in the third electrode 68. Again, a piston based device is used capable of repeated insertion of measured volumes of fluid.

Variation of an applied voltage V₈ across electrodes 64 and 61 results in variation in the curvature of the first meniscus 65 as detailed in the previous embodiment. Variation of applied voltage V₇ across electrodes 68 and 61 results in a similar curvature variation of the second meniscus 66.

The value of applied voltages V₈ and V₇ can differ from each other and be varied independently. Consequently the curvatures of the first fluid meniscus 65 and the second fluid meniscus 66 can differ from each other to provide a convex-concave lens of preferred shape and refractive characteristics.

Shown now in FIG. 6b the curvatures of both meniscus 65 and 66 are varied independently until the desired curvature for each is obtained. Both applied voltages V₇ and V₈ are controlled by a person qualified to manufacture ophthalmic lenses.

The desired curvature for each meniscus 65 and 66 is generally determined by the desired focal power of the ophthalmic lens to be manufactured. In the manufacture of contact lenses the curvature of the second meniscus 66 is determined by using measurements of the curvature of the patient's eyeball. At least part of the information for the desired refractive characteristics of the lens is provided by a patient's optical prescription for eye deviation. As an envisaged alternative, a patient may themself adjust the curvatures of the menisci based upon viewing through the variable lens, optionally with further corrective lenses in place. This eliminates the need for an optical prescription for the patient.

Once the curvature of both meniscus 65 and 66 are as desired, the transparent lacquer of liquid A is cured using a mechanism appropriate to the chemical nature of lacquer used. One example involves the lacquer of liquid A being irradiated with ultraviolet radiation 69. Once cured, lacquer of liquid A is now fixed in the exact form described by the curvature of both menisci 65 and 66. Solid transparent lacquer of liquid A is removed from the fluid container 62 and is an ophthalmic lens 70 custom made to the specific eye deviation correction needs of the patient, shown in FIG. 6c.

In a still further embodiment of the present invention, an alternative electrode configuration may be incorporated to allow anamorphic lens shapes to be achieved.

FIG. 7a, being a cross-section taken in a plane perpendicular to the optical axis of the lens, shows an alternative electrode configuration for use in a variable meniscus apparatus as described in earlier embodiments of the present invention, capable of producing anamorphic lens shapes. This may, for example, in conjunction with the previous embodiment of the present invention, be capable of manufacturing corrective ophthalmic lenses of varying refractive characteristics for astigmatic eye deviation. A plurality of individual rectangular electrodes 72 are arranged side-by-side about the optical axis 76 of the lens to be manufactured, to form a generally cylindrical enclosure. The remaining characteristics of the lens may be as described in relation to the previous embodiments. The electrodes are formed from a metallic material. The cylindrical inner surface described by the arrangement of electrodes is covered with a continuous, uniform thickness, insulating layer 74 formed for example of parylene or Teflon™ AF1600 produced by DuPont™. Each individual electrode is also insulated with respect to the adjacent electrodes although it is alternatively possible for each longitudinal edge of adjacent electrodes to be connected by an electrically resistive film. This film is formed of a less conductive material than that of the electrodes.

Referring now to both FIGS. 1 and 7a, and with substitution of the first electrode 14 with the alternative electrode configuration of a plurality of electrodes, an independently varying voltage can be applied between an electrode similar to the annular electrode 14 and each individual electrode 72. In this embodiment of the invention, a voltage control is provided which is capable of controlling each individual applied voltage independently, or at least differently. Preferably, the electrodes are arranged in pairs on opposite sides of the optical axis 76 and are provided with the same levels of applied voltage, and the applied voltages vary gradually between electrodes in the direction of the lens circumference.

By controlling the voltages to generate a constant voltage difference between each individual electrode 72 and the electrode similar to the annular electrode 14 in the first embodiment, an aspherical lens may be manufactured of a similar specification to those manufactured in previous embodiments.

Through different combinations of individual applied voltages across electrodes it is possible to obtain various meniscus shapes including those of approximately spherical, and anamorphic, e.g. approximately cylindrical and approximately spherocylindrical, natures.

FIG. 8 shows a graphical representation of relative values of voltages in patterns of voltages applied to produce anamorphic lens shapes. Any relative value of voltage applied at an electrode can be determined by taking the radial distance between the two lines 84, 86 at the appropriate angular position corresponding to the angular location of the center of the electrode about the optical axis 85. In the following, the angular positions corresponds the position about the circumference of the arrangement of segment electrodes described using FIG. 5a. The graphical representation shows a plot on perpendicular axes of this variation of voltages corresponding to a cross-sectional view perpendicular to an optical axis of the fluid meniscus lens. The graphical representation shows a first axis 80 and a second axis 82, arranged perpendicular to each other. The first axis 80 corresponds to a cylindrical axis of the meniscus shape. The circular circumferential line 84 is used to represent all the possible locations of the centers of the segment electrodes 30 (not shown in FIG. 8) about the optical axis. Locations corresponding to the centers of two pairs of the rectangular segment electrodes, perpendicular to each other, are shown; 88 and 90 respectively, in this case lying along axes 80 and 82 respectively.

Applied voltage line 86 shows relatively the applied value of voltage corresponding to a point on the circumferential line 84 of the electrode arrangement. In the representation, the radial distance between a point on the applied voltage line 86 and the corresponding point on the circumferential line 84 represents the relative applied voltage, the common radial line lying at a specific angle from one of either axis 80 or 82. By way of example, this is illustrated in FIG. 8 wherein label 92 shows the point on the applied voltage line 86 and label 94 shows the corresponding point on the circumferential line 84. Both of these points lie along the common radial line 96 at angle θ from, in this case, axis 82.

The greater the radial distance between the point on the applied voltage line 86 and the corresponding point on the circumferential line 84, the greater the relative applied voltage. For example, as FIG. 8 shows, a relatively high voltage is applied across segment electrode pair represented by locations 90, whereas a relatively low voltage is applied across segment electrode pair represented by locations 88. The voltages applied across each respective intermediate segment electrode 30, arranged between a member of the segment electrode pair represented by locations 90 and a member of the segment electrode pair represented by locations 88, decreases gradually.

In this embodiment the width of each electrode 72 is less than half, preferably less than one eighth, of the internal diameter of the cylindrical arrangement of electrodes. This involves the use of sufficient electrodes, preferably ten or above, to reduce observation at the center of the meniscus of significant effects caused by discrete steps of meniscus contact angle between the cylindrical walls of the fluid chamber.

As described in previous embodiments of the present invention, the liquid lacquer is cured when the meniscus curvature corresponds to the desired curvature of the lens to be manufactured.

FIG. 7b, being a cross-section taken in a plane perpendicular to the optical axis of the lens, shows a simplified alternative electrode configuration for producing anamorphic meniscus lens shapes. Four rectangular electrodes 77a, 77b, 77c, 77d are arranged about the optical axis 78 of the lens to be manufactured in a square formation with their longitudinal edges parallel, thus forming a square enclosure. The inner surface of the electrodes is covered with a continuous, uniform thickness, insulating layer 79, formed for example of parylene or Teflon™ AF1600.

Referring now to both FIGS. 1 and 7b and with substitution of the first electrode 14 by the alternative construction of four electrodes, a voltage can be applied between a single electrode 77a, 77b, 77c, 77d and an electrode similar to the annular electrode 14 in the first embodiment. Through combination of different independently, or at least differently, applied voltages for each individual electrode 77a, 77b, 77c, 77d, an anamorphic meniscus lens shape which is approximately cylindrical or spherocylindrical can be achieved with a different contact angle between each individual electrode wall and the meniscus lens.

By connecting the voltages applied across opposite electrodes as pairs, in other words electrodes 77a and 77c as a pair, and electrodes 77b and 77d as a pair, and applying the voltages across each connected electrode pair and the annular electrode 14 similarly or differently, it is possible to obtain spherical, cylindrical or spherocylindrical meniscus shapes. Anamorphic meniscus shapes can also be obtained by combination of differently applied voltages across each single electrode and the annular electrode 14.

It is to be understood that further embodiments of the invention are envisaged and that features of one embodiment may be used in other embodiments.

As a further example of the above embodiments, the first liquid A comprises a lacquer, capable of being cured using ultra violet light, for example in the form of acrylate monomers, diacryl, an epoxy lacquer or a sol-gel material. In alternative embodiments the first liquid A does not have to comprise a lacquer but could be of an alternative curable, or otherwise fixable shape, liquid. Such lens elements may also be manufactured in accordance with the present invention to provide a master lens mould element. In this case, liquid A could also be opaque. Liquid A could also be colored with a dye such that colored lenses with desired configurations could be manufactured. Depending on the chemical nature of the material used for lens manufacture the material may be cured by the application of ultraviolet radiation or by alternative methods, for example with heat or with an ‘initiator’ chemical for the curing mechanism. The liquid may also be fixed in shape by methods other than curing, for example by freezing.

Whereas the first liquid A is located above the second liquid B, in the above-described embodiments, alternatively the first liquid A located in the lower part of the fluid container, a single variable meniscus may also be formed with a liquid or vapor layer above the first liquid A and the liquid A fixed in shape to form a lens element of a desired configuration.

In a further envisaged embodiment, the first electrode is shaped in a non-cylindrical rotationally-symmetric configuration. For example, the sides can be frustoconical or in a bell shape. In the described embodiment where the first electrode is replaced with a plurality of individual electrodes arranged about the optical axis, the longitudinal edges of the electrodes are not limited to lie parallel with each other. For example, the individual electrodes may together be arranged to form a frustoconical or bell shape about the optical axis. Such electrode formations can allow easier removal of the manufactured lens from the apparatus and can also allow fluid menisci of certain radii to be achieved more easily.

In a preferred embodiment, the method of lens manufacture may be fully automated wherein the desired characteristics of the lens are controlled for example by a dedicated computer using input lens data, such as an ophthalmic prescription.

It is to be understood that further equivalents and modifications are imagined within the scope of the invention as defined by the attached claims.

1. A method of the manufacture of an optical lens element, said method comprising:
a) providing a fixable liquid separated from a first fluid by a first meniscus;
b) electrically varying a curvature of the first meniscus; and
c) fixing the shape of the fixable liquid when the first meniscus has a curvature with a desired configuration.
characterized in that said fixable liquid is separated from a second fluid by a second meniscus and said method further includes electrically varying a curvature of the second meniscus, wherein said fixable liquid is fixed in step c) when the second meniscus has a curvature with a desired configuration.

2. A method according to claim 1, wherein the fixable liquid comprises a curable liquid.

3. A method according to claim 1, wherein the first fluid comprises a liquid.

4. A method according to claim 1, wherein the fixable liquid is separated from a first electrode by a fluid contact layer and the first fluid is acted upon by a second electrode, and the curvature of the first meniscus is electrically varied by varying an applied voltage across the first and second electrodes.

5. A method according to claim 4, wherein the first electrode forms at least part of a substantially cylindrical configuration of electrodes.

6. A method according to claim 4, wherein the first electrode forms at least part of a non-cylindrical rotationally-symmetric configuration of electrodes.

7. A method according to claim 1, wherein the curvature of the second meniscus is electrically varied generally in accordance with the variation of the curvature of the first meniscus.

8. A method according to claim 1, wherein the curvature of the second meniscus is electrically varied independently of the variation of the curvature of the first meniscus.

9. A method according to claim 1, wherein the second fluid is acted upon by an electrode and wherein the curvature of the second meniscus is varied by the variation of an applied voltage at the electrode acting on the second fluid.

10. A method according to claim 1, wherein the second fluid is a liquid.

11. A method according to claim 1, comprising providing a configuration of a plurality of electrodes and varying voltages applied thereto to form meniscus shapes.

12. A method according to claim 1, wherein the fixable liquid is an insulating liquid and the first and second fluids are electrically conducting liquids.

13. A method according to claim 1, comprising fixing the shape of the fixable liquid by the application of ultraviolet radiation.

14. A method according to claim 1, comprising fixing the shape of the fixable liquid by heat curing or chemical curing.

15. A method according to claim 1, wherein said manufacture of an optical lens element comprises the manufacture of ophthalmic lenses to correct a patient's eye deviation.

16. An optical lens element manufactured using the process of claim 1.

17. Apparatus for the manufacture of an optical lens element, said apparatus including:
a) a receptacle for receiving both a fixable liquid and a first fluid, wherein said fixable liquid is separated from said first fluid by a first meniscus;
b) an electrode configuration arranged to enable the curvature of the first meniscus to be electrically varied; and
c) means for fixing the shape of the fixable liquid.
characterized in that said receptacle is further arranged to receive a second fluid, wherein said fixable liquid is separated from said second fluid by a second meniscus and said electrode configuration is arranged to enable a curvature of the second meniscus to be electrically varied.

18. Apparatus according to claim 17, wherein the fixing means comprises a source of ultraviolet light.

19. Apparatus according to claim 17, further comprising means for repeatedly inserting measured amounts of the fixable liquid into the receptacle.
